(19) United States
(12) Patent Application Publication
(10) Pub. No.: US 2026/0206670 A1
(43) Pub. Date: Jul. 23, 2026

(54) MUD SCRAPER DEVICE FOR AN AGRICULTURAL PACKER WHEEL

(71) Applicant: Dutch Blacksmith Shop Ltd., Pilot Butte (CA)

(72) Inventors: Nicholas Alexander Volsky, Craven (CA); Jayden Gerald Raabel, Regina (CA)

(21) Appl. No.: 19/029,118

(22) Filed: Jan. 17, 2025

(51) Int. Cl. A01B 71/08; A01C 5/06

(52) U.S. Cl. CPC A01B 71/08; A01C 5/068

(57) ABSTRACT

A scraper device is mounted on the supporting frame of an agricultural seeding implement in proximity to a packer wheel that rotates within a rotation plane oriented perpendicularly to a wheel axis of the packer wheel. The scraper device has a mounting frame for mounting on the supporting frame of the packer wheel, a pivot shaft on the mounting frame defining a scraper axis, and a scraper body on the pivot shaft for rotation about the scraper axis. The scraper axis is sloped at an angle in the range of 5 to 50 degrees from the wheel axis, while being parallel to a tangent plane of the packer wheel. The scraper body has radially protruding paddles defining a scraper profile that closely mates with the wheel profile of the packer wheel.

### FIELD OF THE INVENTION

The present invention relates to a scraper device for removal of debris such as mud from an outer profile of a packer wheel on an agricultural implement, and more particularly the present invention relates to a mud scraper device supported rotatably relative to a supporting frame upon which the packer wheel is rotatably supported.

### BACKGROUND

A large number of independent row unit seeding tools rely on a trailing packer or gauge wheel to determine seeding depth. These wheels can often build up with soil or mud, changing their diameter and effective depth, or even plugging entirely so as to stop rotating. Mud scrapers have been developed to address these issues and fall into two main categories: fixed and rotating. Fixed scrapers can have issues with high wear rate, creating damage to the packer tire, and even increased plugging resulting in stopped rotation. Currently available rotating scrapers typically rotate about an axis that is parallel to the rotation plane of the wheel in proximity to the outermost perimeter edge of the wheel. Accordingly, such rotating scrapers only clear a small portion of the tire or wheel profile, generally focused on the outer diameter of the tire. This is especially true and problematic with V-shaped packers such as used on the John Deere 1870 Conserva Pak® seeding unit by John Deere where the side profile of the packer wheel is one of the critical surfaces for packing and depth gauging.

### SUMMARY OF THE INVENTION

According to one aspect of the invention there is provided a wheel scraper device for use with a packer wheel supported on a supporting frame of an agricultural seeding implement in which the packer wheel rotates about a wheel axis of the packer wheel within a rotation plane oriented perpendicularly to the wheel axis, the wheel scraper device comprising:
a pivot shaft defining a scraper axis;
a scraper body supported on the pivot shaft for rotation about the scraper axis, the scraper body defining a scraper profile which rotates about the scraper axis with the scraper body; and
a mounting frame arranged to support the pivot shaft on the supporting frame of the agricultural implement such that the scraper profile is arranged for alignment with a wheel profile of the packer wheel for scraping debris from the wheel profile;
wherein the scraper axis is oriented transversely at a slope to the rotation plane of the packer wheel; and
wherein the scraper axis is oriented transversely at a slope to the wheel axis of the packer wheel.

The rotating scraper with tire matching profile allows a larger portion of the tire profile to have soil removed from it, especially in the case of V-shaped packers. The rotation axis angle being increased from parallel with the tire rotation means greater drive engagement between the packer and rotating scraper as well as creating soil movement along the axis of the scraper to ensure sufficient soil clearing. An increased allowable tire to scraper clearance reduces tire damage and chances of tire stalling.

Preferably the scraper profile is shaped to mate with the wheel profile of the packer wheel. For example, when the wheel profile is V-shaped, the scraper profile may be frustoconical for mating with the wheel profile. Alternatively, when the wheel profile is round, the scraper profile may be concave for mating with the wheel profile.

Preferably the mounting frame is arranged to support the scraper profile of the scraper body in spaced relationship with the packer wheel at a distance of less than ½ an inch. More preferably, the mounting frame may be arranged to support the scraper profile of the scraper body in spaced relationship with the packer wheel at a distance of between 0 and ¼ of an inch. The mounting frame is preferably adjustable so as to be arranged to support the scraper profile of the scraper body at an adjustable distance relative to the packer wheel.

The mounting frame is preferably arranged to support the pivot shaft on the supporting frame of the agricultural implement such that the scraper axis is oriented at a slope to the wheel axis in a range of 5 to 50 degrees, and more preferably at a slope to the wheel axis in a range of 20 to 40 degrees. Preferably the scraper axis is oriented parallel to a tangent plane that is oriented tangentially to the packer wheel.

The scraper profile is preferably symmetrically about a symmetry plane oriented perpendicularly to the scraper axis. In this instance, the mounting frame is preferably arranged to support the pivot shaft on the supporting frame of the agricultural implement such that the scraper profile is axially centered relative to the packer wheel.

The scraper body may comprise a plurality of paddles protruding radially outward to respective outermost edges, in which the outermost edge of each paddle define the scraper profile thereon extending axially relative to the scraper body. For example, the scraper body may include 3, 4, 5, 6, 7 or more paddles.

The mounting frame may be connected to a first end of the pivot shaft such that an opposing second end of the pivot shaft is a free end. In this instance, the scraper body may be slidably removable from the second end of the pivot shaft. Preferably a retainer member, for example a nut threaded onto the second end of the pivot shaft, is removably mounted onto the second end of the pivot shaft to selectively retain the scraper body on the pivot shaft.

According to the illustrated embodiment, the mounting frame is arranged for attachment to the supporting frame of the agricultural implement adjacent to the wheel axis of the packer wheel. More particularly, the mounting frame may include a mounting arm arranged to extend radially between the supporting frame and the pivot shaft, the mounting arm being adjustable in length radially of the packer wheel so as to adjust a spacing of the scraper profile of the scraper body relative to the wheel profile of the packer wheel.

### BRIEF DESCRIPTION OF THE DRAWINGS

One embodiment of the invention will now be described in conjunction with the accompanying drawings in which:

FIG. 1 is a perspective view of a seeding unit of an agricultural implement including a packer wheel for closing a seed furrow formed by the seeding unit for deposit of seed therein, in which the wheel scraper device according to the present invention is shown in operative relation to the packer wheel for scraping mud from the packer wheel in operation;

FIG. 2 an enlarged perspective view of the wheel scraper device shown mounted relative to the packer wheel;

FIG. 3 is another perspective view of the wheel scraper device shown mounted relative to the packer wheel;

FIG. 4 is a rear elevational view of the wheel scraper device shown mounted relative to the packer wheel;

FIG. 5 is a side elevational view of the wheel scraper device shown mounted relative to the packer wheel;

FIG. 6 is a perspective view of the scraper body of the wheel scraper device shown in isolation;

FIG. 7 is a partly sectional view of the scraper body of the wheel scraper device;

FIG. 8 is a top view of the scraper profile of the scraper body in mating relationship with the wheel profile of the packer wheel; and

FIG. 9 is a view of the scraper body along a radial axis of the packer wheel illustrating an orientation of the scraper axis relative to wheel axis and the rotation plane of the packer wheel.

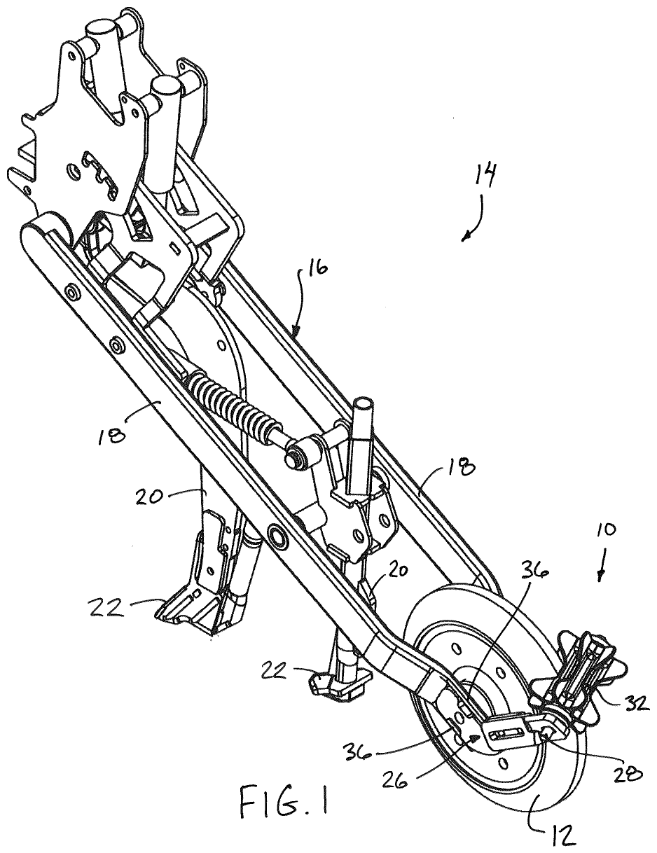

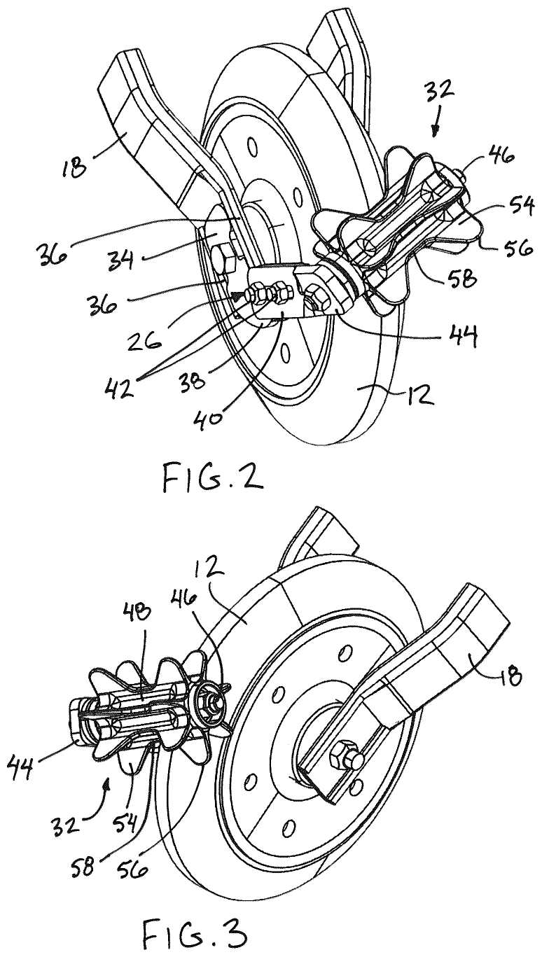

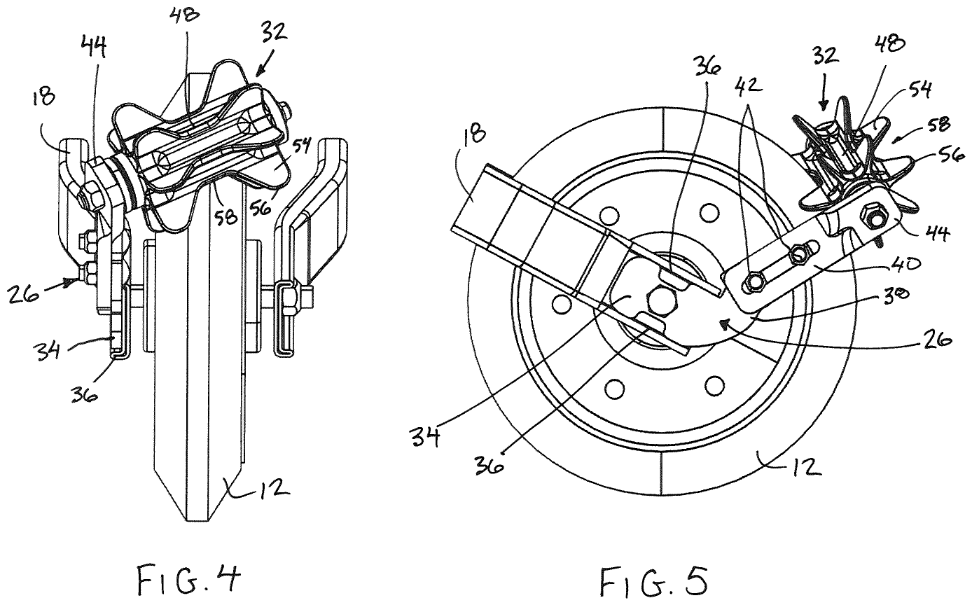

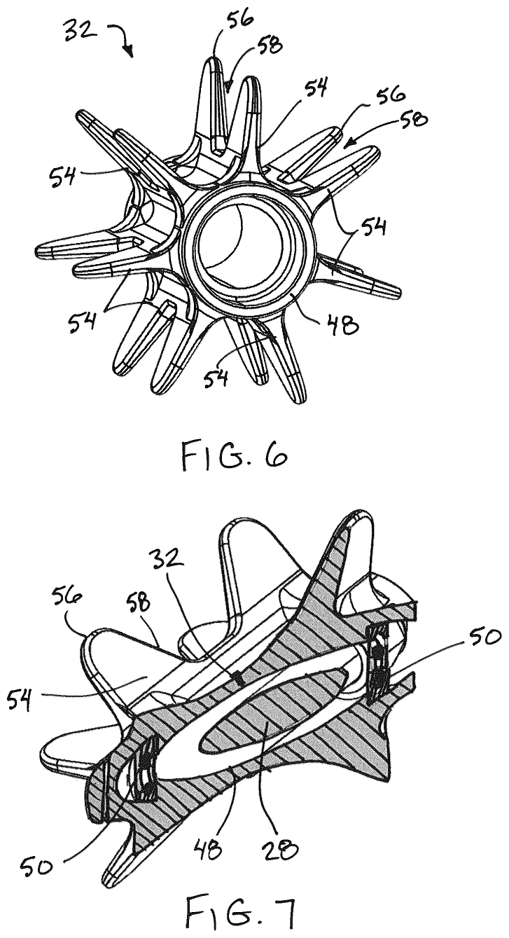

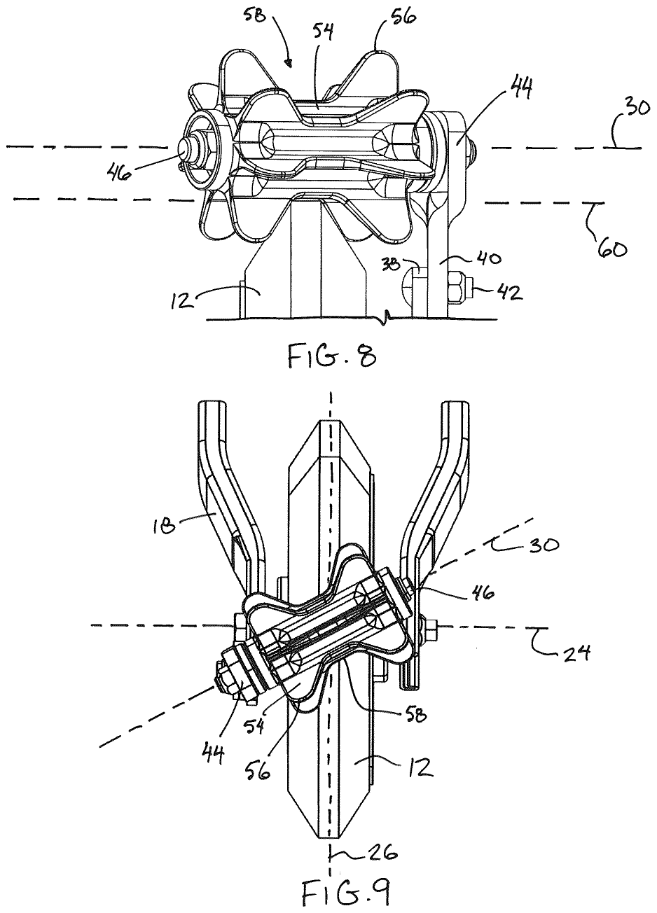

In the drawings like characters of reference indicate corresponding parts in the different figures.

### DETAILED DESCRIPTION

Referring to the accompanying figures, there is illustrated a packer wheel scraper device generally indicated by reference numeral 10. The scraper device 10 is particularly suited for scraping debris such as mud from the outer perimeter profile of an agricultural packer wheel 12 such as the type found on a seeding unit 14 of an agricultural seeding implement (not shown).

The seeding unit 14 typically comprises a main supporting frame 16 having a pair of supporting arms 18 extending generally downwardly and rearwardly from a forward end of the supporting frame 16 that is arranged for mounting on a toolbar of the agricultural seeding implement to respective rear ends supporting the packer wheel 12 thereon. The supporting frame 16 of the seeding unit 14 according to the illustrated embodiment further includes one or more tool shanks 20 supported on the arms 18 to support openers 22 thereon to form respective furrows in the ground into which seed or fertilizer is deposited.

The packer wheel 12 is rotatably supported on an axle extending in a lateral direction between the trailing ends of the supporting arms 18 for closing and packing the furrow formed by the openers 22. The axle is fixed relative to the arms 18 by nuts threaded onto opposing ends of the axle respectively. The packer wheel 12 is rotatable about the axle which defines a wheel axis 24 of the packer wheel. The packer wheel 12 rotates about the wheel axis within a rotation plane 26 that is oriented perpendicularly to the wheel axis.

In the illustrated embodiment, the packer wheel 12 has a wheel profile defined by the shape of the outer perimeter boundary of the wheel that is V-shaped. In other embodiments, the wheel may have a different cross-sectional shape defining a different wheel profile such as a semi-circular profile when the perimeter boundary of the wheel is rounded.

The wheel scraper device 10 generally includes (i) a mounting frame 26 arranged for mounting onto one of the arms 18 of the supporting frame 16 on the implement, (ii) a pivot shaft 28 extending from the mounting frame 26 and defining a scraper axis 30, and (iii) a scraper body 13 supported on the pivot shaft 28 for rotation about the scraper axis in which the scraper body 32 defines a scraper profile supported in close proximity to the wheel profile of the packer wheel in use for removing mud and debris from the wheel.

The mounting frame 26 generally includes a bracket member 34 comprising a plate with a central aperture therein arranged for mounting onto the end of the axle of the packer wheel. The plate mounts against the outer side of one of the supporting arms 18 with the central aperture aligned with the axle of the packer wheel so that the existing threaded fastener at the end of the axle can be used to also clamp the plate defining the bracket member 34 against the outer side of the supporting arm 18 while mounting the axle to the arm. The plate forming the bracket member 34 is shaped to fit between existing flanges 36 formed on the supporting arm 18 so that the bracket member mates non-rotatably the supporting arm when bolted in fixed relation thereon.

The mounting frame 26 of the scraper device further includes a mounting arm extending generally radially from the bracket member 34 at the wheel axis 24 to an opposing outer end supporting the pivot shaft 28 thereon. Mounting arm includes a first end portion 38 adjacent the first end which is fixed to the bracket and a second end portion 40 supporting the pivot shaft in fixed relation to the outer end thereof. The first end portion 38 and the second end portion 40 of the mounting arm overlap one another in the longitudinal direction by an adjustable mount to vary the overall length of the mounting arm which in turn varies the distance of the pivot shaft 28 from the wheel axis to vary the operating gap between the scraper body 32 and the outer periphery of the packer wheel.

A pair of mounting fasteners 42 extend through cooperating apertures in the first end portion 38 and the second end portion 40 of the mounting arm at the region of overlap between the end portions in which the apertures in at least one of the end portions comprise elongated slots to enable fastening of the first end portion 38 and the second end portion 40 alongside one another at an adjustable positioning in the longitudinal direction. The first and second end portions 38 and 40 are formed of a flat plate material mounted flat against one another in a mounted arrangement. The outer end 44 of the second end portion 40 is twisted relative to the remaining end portion about a longitudinal axis of the mounting arm which is radial of the wheel axis 24. The twisted end 44 serves as a mounting surface for one end of the pivot shaft 28 upon which the scraper body 32 is rotatably supported. The pivot shaft is mounted perpendicularly to the twisted end 44 of the mounting arm.

The pivot shaft 28 is an elongated shaft which is bolted at a first end to the twisted end 44 of the mounting arm to extend perpendicularly outward therefrom to an opposing second end 46 defining a free end which is freely suspended generally above the packer wheel.

The scraper body 34 includes a cylindrical or tubular core 48 having a through bore which receives the pivot shaft 28 extending axially therethrough. A pair of bearings 50 are received within respective counterbores at opposing ends of the through bore of the core 48 to support the scraper body 32 rotatably on the pivot shaft at axially spaced locations. A suitable retainer member 52, for example a threaded nut, is threaded onto the second end 46 of the pivot shaft 28 to retain the scraper body axially on the pivot shaft. Removal of the retainer member 52 allows the scraper body 32 to be slidably removed over the second end of the pivot shaft by sliding along the scraper axis 30 of the pivot shaft.

The scraper body 32 also includes a plurality of paddles 54 protruding radially outward from the core 48 at evenly spaced apart positions in the circumferential direction. Each paddle 54 is a generally planar shaped body extending axially along substantially the full length of the scraper body while extending radially from the core 48 to an outermost free edge 56 of the paddle. The outermost edge 56 defines a scraper profile of the scraper body which is consistent from one paddle to the next.

More particularly, the outermost edge 56 is shaped to define a recess 58 formed centrally therein where the radial dimension of the paddle is reduced at an axially centred location relative to the length of the scraper body in the direction of the scraper axis 30. The mounting frame 26 supports the scraper body 32 such that the scraper body is also axially centred relative to the packer wheel for aligning the recess 58 of the scraper profile with the corresponding shaped wheel profile at the outer periphery of the packer wheel. The recess 58 is generally symmetrical about a symmetry plane that is perpendicular to the scraper axis 30 at an axially centred location for mating with the wheel profile that is similarly symmetrical about a symmetry plane that is axially centred along the wheel axis. The recess 58 is axially centred relative to the packer wheel at the rotation plane.

In the illustrated embodiment in which the wheel profile defines a V-shaped profile, the recess 58 is frustoconical in shape so as to generally match the V-shaped profile of the wheel. The dimension of the recess 58 in the axial direction of the scraper body is generally wider than the corresponding dimension of the wheel profile in the axial direction of the wheel axis; however, the scraper axis is mounted non-perpendicularly to the wheel axis so that the perceived dimensions of the recess 58 defining the scraper profile when viewed along a tangential axis of the packer wheel is approximately equal to the wheel profile of the packer wheel as best shown in FIG. 8.

The mounting frame 26 specifically supports the pivot shaft defining the scraper axis to be parallel to a tangent plane 60 that is oriented tangentially to the packer wheel as shown in FIG. 8. The scraper axis however is sloped relative to the wheel axis 24 and relative to the rotation plane 26 of the packer wheel as best shown in FIG. 9. According to the illustrated embodiment, the scraper axis 30 lies approximately 30 degrees from the wheel axis 24 and approximately 60 degrees from the rotation plane 26. The scraper body however can be oriented effectively with the scraper axis being oriented at a range of between 5 and 50 degrees from the wheel axis 24, but is more preferably in a range of 20 degrees to 40 degrees relative to the wheel axle 24. This corresponds to the scraper axis 30 being within a range of 40 to 85 degrees to the rotation plane 26, or more preferably in a range of 50 to 70 degrees to the rotation plane 26. In each instance however the scraper axis remains generally parallel to the tangent plane 60 while also being axially centred relative to the rotation plane 26. The scraper profile of the illustrated embodiment is suited for mounting at the illustrated slope of the scraper axis relative to the wheel axis and the rotation plane. In further embodiments, when the scraper body is mounted at different slopes, the dimensions of the recess 58 defining the scraper profile are varied so that the shape of the scraper profile when viewed along a tangential axis according to FIG. 8 remains closely matching the corresponding wheel profile of the packer wheel.

In use, the wheel scraper device 10 is mounted onto the supporting frame 16 of a seeding unit using the bracket member 34 that mounts onto the frame at the wheel axle 24. The user adjusts the length of the first end portion 38 and second end portion 40 collectively forming the mounting arm to adjust the position of the scraper body in a generally radial direction relative to the packer wheel so that the scraper profile closely follows the shape of the wheel profile. Typically, the scraper body is mounted so that the scraper profile is within ½ an inch of radial gap from the perimeter edge of the packer wheel, however the spacing can be adjusted to a preferred range of between 0 and ¼ of an inch.

The mounting frame 26 supporting the pivot shaft 28 and the scraper body 32 thereon serve to support the scraper body for rotation about the scraper axis such that the scraper axis is suitably oriented relative to the wheel axis 24 and the rotation plane 26 as specified above.

In the event that the scraper body becomes damaged, for example breakage of one or more paddles, removal of the retainer member 52 from the second end of the pivot shaft 28 allows the scraper body to be slidably removed and replaced with an undamaged scraper body.

In the illustrated embodiment, the scraper body includes seven paddles 54 which are evenly spaced apart from one another in the circumferential direction so that sufficient paddles engage the packer wheel for removing sufficient mud and debris from the packer wheel during operation. In further embodiments, the scraper body includes at least four paddles, and preferably at least six paddles to ensure sufficient contact of the scraper profile with the wheel profile of the packer wheel to effectively clear debris in use.

In operation, the packer wheel 12 rolls along the ground and typically collects mud from the ground as collected debris. The rotating packer wheel 12 with a layer of mud thereon is engaged by the scraper body 32 to cause a corresponding counter-rotation of the scraper body. The smaller diameter of the scraper body ensures that the scraper body rotates at a much higher rate of rotation than the packer wheel so that the paddles collect and throw accumulated mud from the packer wheel to clear the mud from the packer wheel in operation.

Since various modifications can be made in the invention as herein above described, and many apparently widely different embodiments of same made, it is intended that all matter contained in the accompanying specification shall be interpreted as illustrative only and not in a limiting sense.

1. A wheel scraper device for use with a packer wheel supported on a supporting frame of an agricultural seeding implement in which the packer wheel rotates about a wheel axis of the packer wheel within a rotation plane oriented perpendicularly to the wheel axis, the wheel scraper device comprising:
a pivot shaft defining a scraper axis;
a scraper body supported on the pivot shaft for rotation relative to the pivot shaft about the scraper axis, the scraper body defining a scraper profile which rotates about the scraper axis with the scraper body; and
a mounting frame arranged to support the pivot shaft on the supporting frame of the agricultural implement such that the scraper profile is arranged for alignment with a wheel profile of the packer wheel for scraping debris from the wheel profile;
wherein the scraper axis is oriented transversely at a slope to the rotation plane of the packer wheel; and
wherein the scraper axis is oriented transversely at a slope to the wheel axis of the packer wheel.

2. The wheel scraper device according to claim 1 wherein the scraper profile is shaped to mate with the wheel profile of the packer wheel.

3. The wheel scraper device according to claim 2 wherein the wheel profile is V-shaped and the scraper profile is frustoconical for mating with the wheel profile.

4. The wheel scraper device according to claim 2 wherein the wheel profile is round and the scraper profile is concave for mating with the wheel profile.

5. The wheel scraper device according to claim 1 wherein the mounting frame is arranged to support the scraper profile of the scraper body in spaced relationship with the packer wheel at a distance of less than ½ an inch.

6. The wheel scraper device according to claim 1 wherein the mounting frame is arranged to support the scraper profile of the scraper body in spaced relationship with the packer wheel at a distance of between 0 and ¼ of an inch.

7. The wheel scraper device according to claim 1 wherein the mounting frame is adjustable so as to be arranged to support the scraper profile of the scraper body at an adjustable distance relative to the packer wheel.

8. The wheel scraper device according to claim 1 wherein the mounting frame is arranged to support the pivot shaft on the supporting frame of the agricultural implement such that the scraper axis is oriented at a slope to the wheel axis in a range of 5 to 50 degrees.

9. The wheel scraper device according to claim 1 wherein the mounting frame is arranged to support the pivot shaft on the supporting frame of the agricultural implement such that the scraper axis is oriented at a slope to the wheel axis in a range of 20 to 40 degrees.

10. The wheel scraper device according to claim 1 wherein the mounting frame is arranged to support the pivot shaft on the supporting frame of the agricultural implement such that the scraper axis is oriented parallel to a tangent plane oriented tangentially to the packer wheel.

11. The wheel scraper device according to claim 1 wherein the scraper profile is symmetrically about a symmetry plane oriented perpendicularly to the scraper axis.

12. The wheel scraper device according to claim 1 wherein the mounting frame is arranged to support the pivot shaft on the supporting frame of the agricultural implement such that the scraper profile is axially centered relative to the packer wheel.

13. The wheel scraper device according to claim 1 wherein the scraper body comprises a plurality of paddles protruding radially outward to respective outermost edges, the outermost edge of each paddle defining the scraper profile thereon extending axially relative to the scraper body.

14. The wheel scraper device according to claim 13 wherein the scraper body includes at least 4 of the paddles.

15. The wheel scraper device according to claim 13 wherein the scraper body includes at least 6 of the paddles.

16. The wheel scraper device according to claim 1 wherein the mounting frame is connected to a first end of the pivot shaft such that an opposing second end of the pivot shaft is a free end, wherein the scraper body is slidably removable from the second end of the pivot shaft, and wherein a retainer member is removably mounted onto the second end of the pivot shaft to selectively retain the scraper body on the pivot shaft.

17. The wheel scraper device according to claim 16 wherein the retainer member comprises a nut threaded onto the second end of the pivot shaft.

18. The wheel scraper device according to any one of claims 1 through 17 wherein the mounting frame is arranged for attachment to the supporting frame of the agricultural implement adjacent to the wheel axis of the packer wheel.

19. The wheel scraper device according to claim 18 wherein the mounting frame includes a mounting arm arranged to extend radially between the supporting frame and the pivot shaft, the mounting arm being adjustable in length radially of the packer wheel so as to adjust a spacing of the scraper profile of the scraper body relative to the wheel profile of the packer wheel.

20. The wheel scraper device according to claim 1 in combination with the packer wheel.
